(19) United States
(12) Patent Application Publication
(10) Pub. No.: US 2010/0153078 A1
(43) Pub. Date: Jun. 17, 2010

(54) Image processing system and method for simulating real effects of natural weather in video film

(75) Inventor: Zhen Zhang, Hangzhou City (CN)

Correspondence Address: BACON & THOMAS, PLLC, 625 SLATERS LANE, FOURTH FLOOR, ALEXANDRIA, VA, 22314-1176, US

(73) Assignee: ArcSoft Hangzhou Co., Ltd., Hangzhou City (CN)

(21) Appl. No.: 12/591,337

(22) Filed: Nov. 17, 2009

(30) Foreign Application Priority Data
Dec. 11, 2008 (CN) 200810184107.0

(51) Int. Cl. G06G 7/48; G06F 17/10; G09G 5/02

(52) U.S. Cl. 703/2; 703/6; 345/589

(57) ABSTRACT

The present invention is to provide an image processing system and a method thereof implemented to a series of images in a video film of an outdoor scene, which includes: defining types of free-falling objects (such as raindrops, snowflakes or hailstones) related to natural weather; reading information of a selected type of the free-falling objects so as to randomly generate falling positions and vertical falling textures of the free-falling objects in each image; detecting a grayscale value of the image, and defining a certain region of the image where the grayscale value exceeds a predetermined grayscale value as a deposited region; simulating a deposited status of the free-falling objects in each deposited region; and integrating the vertical falling texture and the deposited status into the video film for simulating the free-falling objects in the images, so as to produce effects approximating real effects of natural weather in the video film.

### FIELD OF THE INVENTION

The present invention relates to an image processing system and a method thereof, more particularly to an image processing system and a method implemented to a series of images in a video film of an outdoor scene for simulating free-falling objects (such as raindrops, snowflakes, hailstones, or sand) related to natural weather in the images, so as to produce effects approximating real effects of natural weather in the video film.

### BACKGROUND OF THE INVENTION

Recently, with the rapid advancement of digital photography technologies, various electronic devices (such as digital cameras, digital video cameras, notebook computers, and mobile phones) equipped with digital image-capturing elements are continuously developed and improved, with increasingly enhanced image quality, steadily decreasing product volumes, and gradually descending selling prices. Therefore, these electronic devices capable of capturing images are more and more popular in the market, and people have been accustomed to using these image-capturing electronic devices to record moments in their daily life and work.

Especially, urban landscape designers, streetscape designers, or people interested in home environment design would normally use the aforesaid image-capturing electronic devices to record video films of urban landscape, streetscape or home environment before starting a related design, so that real scenic effects of different weather conditions (such as rain, snow, hail, or sandstorm) can be simulated in the video films as a reference for streetscape or home environment design. In addition, after the urban landscape, streetscape or home environment design is completed using an image design software, it is also desirable to speedily simulate real scenic effects of different weather conditions in virtual video films of the designed streets or home environment, so that the street or home environment design can be adjusted until the final version shows optimal visual effects of different weather conditions in accordance with design requirements. Therefore, it is a common need shared by urban landscape designers, streetscape designers, home environment designers, and those interested in relevant designs to have an image processing software capable of simulating real scenic effects of different weather conditions in actually recorded or virtual video films of urban landscape, streetscape, or home environment.

More specifically, different objects (such as raindrops, snowflakes, hailstones, or sand) fall from the sky under different weather conditions (such as rain, snow, hail, or sandstorm). These objects, depending on their sizes, degrees of transparency, and falling speeds, impart various textures to and have diverse impacts on outdoor scenery. In addition, some lightweight falling objects (such as snowflakes or sand) are easily influenced by wind fields in outdoor scenery so as to produce dynamically changing textures in the outdoor scenery and thus have greater impacts on the outdoor scenery than do relatively heavy falling objects. Hence, an important issue to be addressed by the present invention is how to simulate real effects of natural weather in a video film of an outdoor scene according to the different properties of falling objects (such as raindrops, snowflakes, hailstones, or sand) under different weather conditions, so that the simulated video film shows various effects (such as analogous gradation, ground deposition, and light reflection) of the free-falling objects and provides a virtual outdoor scene which approximates the real outdoor scene under natural weather conditions.

In view of the aforementioned common need of urban landscape designers, streetscape designers, or those interested in home environment design, the inventor of the present invention conducted extensive research and finally succeeded in developing an image processing system and method for simulating real effects of natural weather in a video film as disclosed herein.

### BRIEF SUMMARY OF THE INVENTION

A primary objective of the present invention is to provide an image processing system for simulating free-falling objects related to natural weather in a series of images in a video film of an outdoor scene. The image processing system includes: a display device for showing a simulated video film; a storage device for storing an image processing procedure; and a processor coupled to the storage device for executing the image processing procedure, wherein the image processing procedure includes: defining types of the free-falling objects, wherein each type of the free-falling objects corresponds to a predetermined size, a predetermined shape, a predetermined transparency, and a predetermined falling speed; reading the size, the shape, the transparency, and the falling speed of the free-falling objects according to a selected type of the free-falling objects so as to randomly generate falling positions of the free-falling objects and form a vertical falling texture of the free-falling objects in each of the images; detecting a grayscale value of each of the images, and defining a certain region of the image where the grayscale value exceeds a predetermined grayscale value as a deposited region of the free-falling objects; simulating a deposited status of the free-falling objects in each of the images according to a status of the free-falling objects; and integrating the vertical falling texture and the deposited status of the free-falling objects into the video film of the outdoor scene.

Another objective of the present invention is to provide an image processing method which is applied to a video film of an outdoor scene so as to simulate effects of free-falling objects (such as raindrops, snowflakes, hailstones, or sand) in a series of images of the video film. The method includes steps of: defining types of the free-falling objects, wherein each of the types corresponds to a predetermined size, a predetermined shape, a predetermined property, and a predetermined falling speed; randomly generating falling positions of the free-falling objects according to a selected type of the free-falling objects so as to form a vertical falling texture of the free-falling objects in each of the images; detecting a grayscale value of each of the images and defining a certain region of the image where the grayscale value exceeds a predetermined grayscale value as a deposited region of the free-falling objects; simulating a deposited status (such as water-deposited status or snow-deposited status) of the free-falling objects in each of the images according to a status (such as liquid state or solid state) of the free-falling objects; and finally adjusting a brightness of each of the images according to the property (such as light reflection or transparency) of the free-falling objects. In the present invention, the number, the size, and the deposited amount of the free-falling objects are adjustable to enable the method of the present invention to simulate various effects (such as analogous gradation, ground deposition, and light reflection) of the free-falling objects in the video film. As a result, the outdoor scene shown in the video film is provided with simulated effects approximating real effects of natural weather (such as rain, snow, hail, or sandstorm).

### BRIEF DESCRIPTION OF THE SEVERAL VIEWS OF THE DRAWINGS

The structure and the technical means adopted by the present invention to achieve the above and other objectives can be best understood by referring to the following detailed description of the preferred embodiments and the accompanying drawings, wherein:

FIG. 1 is a schematic view of processing modules according to a first preferred embodiment of the present invention;

FIG. 2 is a flowchart of an image processing method according to the first preferred embodiment of the present invention;

FIG. 3 is a schematic view of processing modules according to a second preferred embodiment of the present invention;

FIG. 4 is a flowchart of an image processing method according to the second preferred embodiment of the present invention; and

FIG. 5 is a flowchart for building up a three-dimensional wind field according to the second preferred embodiment of the present invention.

### DETAILED DESCRIPTION OF THE INVENTION

The present invention provides an image processing system and method for simulating real effects of natural weather in a video film, wherein the image processing system is a personal electronic apparatus (such as a computer, a digital camera, etc.) for processing a video film of an outdoor scene captured by an electronic device capable of capturing images or a video film of an outdoor scene created by an image design software. The video film includes a series of images. The image processing system and method according to the present invention simulate effects of objects (such as raindrops, snowflakes, hailstones, or sand) free-falling from the sky in each of the images so as to make the video film more interesting.

The image processing system of the present invention comprises: a display device, a storage device, and a processor. The display device is configured to show a simulated video film for users to view. The storage device is a hard disk or an optical disk and stores an image processing procedure composed of computer executable commands. The processor executes the image processing procedure stored in the storage device, so as to simulate effects of objects free-falling from the sky in a video film of an outdoor scene.

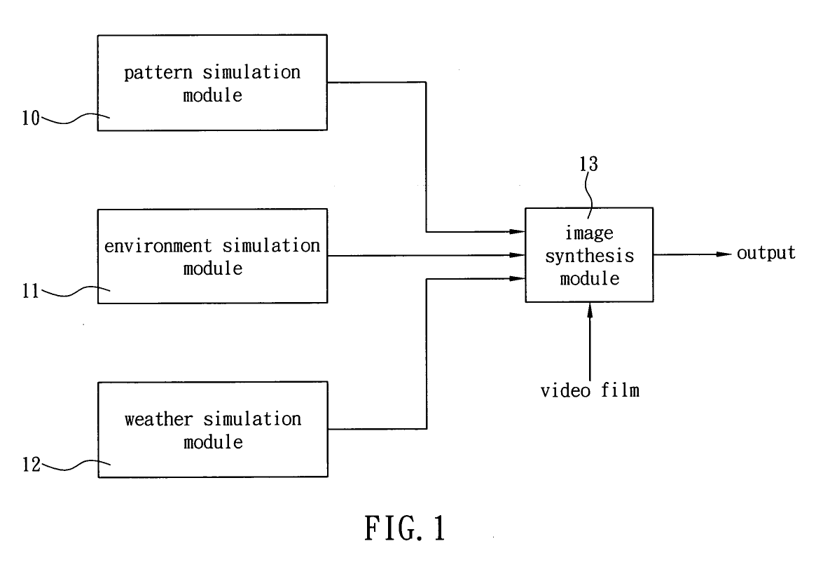

Referring to FIG. 1, in a first preferred embodiment of the present invention where no consideration is given to the influence of wind fields in the outdoor scene on the free-falling objects, the image processing procedure essentially comprises four modules, namely a pattern simulation module 10, an environment simulation module 11, a weather simulation module 12, and an image synthesis module 13. The pattern simulation module 10 provides types of patterns (such as raindrops, snowflakes, hailstones, or sand) of various free-falling objects, wherein the types are defined in advance and each correspond to a predetermined size, a predetermined shape, a predetermined property, and a predetermined falling speed. Thus, when a user selects to simulate a certain type of free-falling objects, the pattern simulation module 10 generates falling positions of the free-falling objects accordingly, so as to form a vertical falling texture (such as raining lines or snowing lines) of the free-falling objects. The environment simulation module 11 detects a grayscale value of each of the images in order to define a certain region of the image where the grayscale value exceeds a predetermined grayscale value (i.e., a brighter region) as a deposited region of the free-falling objects and then simulate a deposited status (such as water-deposited status or snow-deposited status) of the free-falling objects in the deposited region according to a status (such as liquid state or solid state) of the free-falling objects. Furthermore, as the property (such as light reflection or transparency) of the free-falling objects directly affects a brightness of the outdoor scene, the weather simulation module 12 adjusts a brightness of each of the images according to the property of the free-falling objects. For example, on a rainy day, the environmental brightness is darker than on a sunny day due to the shade of clouds, so that the grayscale value of a highly bright outdoor scene should be lowered. On a snowy day, however, the environmental brightness is not apparently different from that on a sunny day due to the reflection of snow, so that it is unnecessary to increase the brightness of each of the images. Moreover, the image synthesis module 13 integrates results of the pattern simulation module 10, the environment simulation module 11, and the weather simulation module 12 into the video film of the outdoor scene, so as to simulate the patterns and various effects (such as analogous gradation, ground deposition, and light reflection) of the free-falling objects in the video film. As a result, the outdoor scene shown in the video film is provided with simulated effects approximating real effects of natural weather (such as rain, snow, hail, or sandstorm).

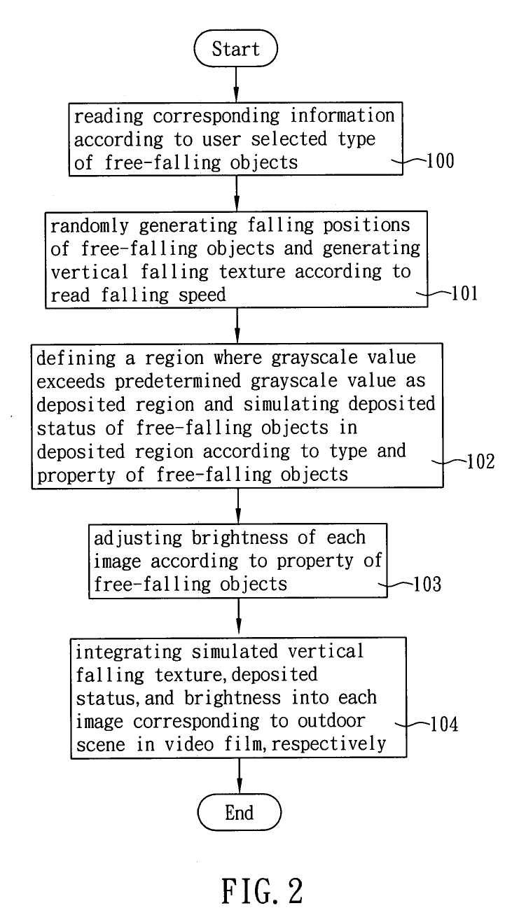

Referring now to FIG. 2, the image processing system in the first preferred embodiment of the present invention involves an image processing method comprising the following steps.

In a step 100, the size, the shape, the transparency, and the falling speed corresponding to the free-falling objects are read according to the type of the free-falling objects selected by the user. Taking raindrops for example, in the first preferred embodiment of the present invention, 32×2 pixels are used to present the vertical texture of raining lines formed by the raindrops while a grayscale value of 200 is used to represent the transparency of the raindrops. In addition, in the first preferred embodiment of the present invention, the method determines a possible form of the free-falling objects in the simulated outdoor scene according to the selected type of the free-falling object. Taking snowflakes for example, the method reads snowflakes of different shapes and three-dimensional effects so as to generate snowflakes rich in diversity and gradation, thereby enhancing the three-dimensional effects of a snowy scene. In other embodiment of the present invention, the pattern, the size, the transparency, and the falling speed corresponding to the free-falling objects are designed so as to be adjustable by the user.

In a step 101, falling positions of the free-falling objects are randomly generated, and a vertical falling texture of the free-falling objects is generated according to the read falling speed of the free-falling objects. Taking raining lines for example, in the first preferred embodiment of the present invention, the falling speed of the raining lines is defined by Newton's law: V=V₀+gt, wherein g=9.8.

In a step 102, a grayscale value of each of the images is detected so as to define a certain region of the image where the grayscale vale exceeds a predetermined grayscale value (i.e., a brighter region) as a deposited region of the free-falling objects. Then, a deposited status of the free-falling objects in the deposited region is simulated according to a status (such as liquid state or solid state) of the free-falling objects. In other embodiments of the present invention, a deposited amount of the free-falling objects in the deposited region is designed so as to be adjustable by the user.

In a step 103, a brightness of each of the images is adjusted according to the property (such as light reflection or transparency) of the free-falling objects. For example, on a rainy day, the environmental brightness is darker than on a sunny day due to the shade of clouds, so that the grayscale value of a highly bright outdoor scene should be lowered. On a snowy day, however, the environmental brightness is not apparently different from that on a sunny day, so that it is unnecessary to increase the brightness of each of the images.

In a step 104, the simulated vertical falling texture of the free-falling objects, the simulated deposited status of the free-falling objects in the deposited region, and the adjusted brightness of each of the images are integrated respectively into each of the images corresponding to the outdoor scene in the video film, so as to simulate various effects of the free-falling objects (such as analogous gradation, ground deposition, and light reflection) in the video film. As a result, the outdoor scene shown in the video film is provided with scenic effects approximating real effects of natural weather (such as rain, snow, hail, or sandstorm).

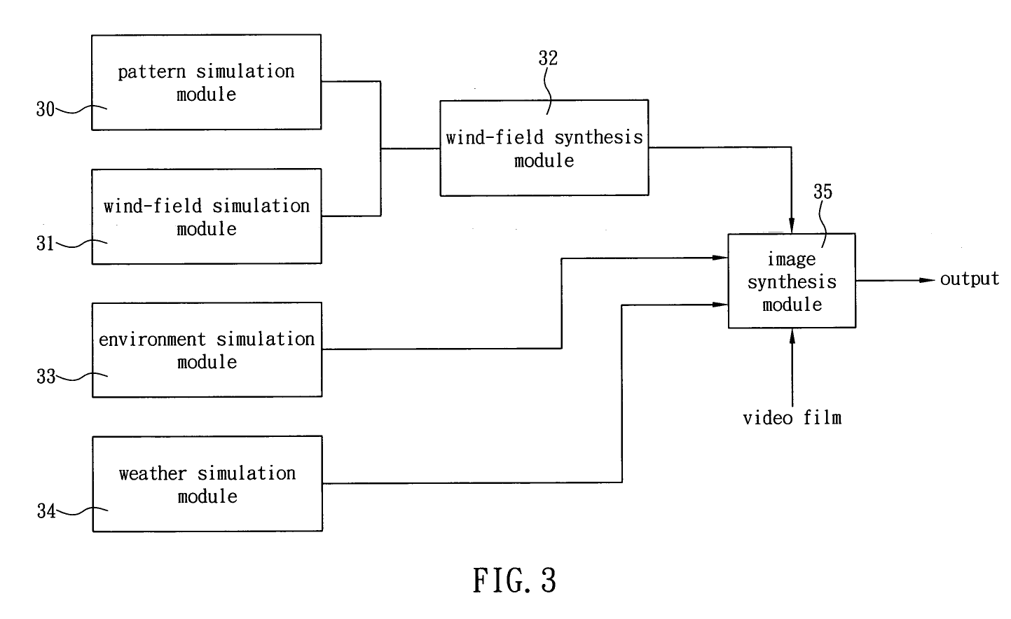

Referring to FIG. 3, in a second preferred embodiment of the present invention where the influence of wind fields in the outdoor scene on the free-falling objects is taken into consideration, the image processing procedure comprises a pattern simulation module 30, a wind-field simulation module 31, a wind-field synthesis module 32, an environment simulation module 33, a weather simulation module 34, and an image synthesis module 35. Therein, the pattern simulation module 30, the environment simulation module 33, the weather simulation module 34, and the image synthesis module 35 have the same functions as the pattern simulation module 10, the environment simulation module 11, the weather simulation module 12, and the image synthesis module 13 in the first preferred embodiment and therefore are not described repeatedly herein. In the second preferred embodiment of the present invention, the wind-field simulation module 31 applies air dynamic properties of wind, fields (such as the Boltzmann equation in air dynamics) to build up a three-dimensional wind field in a simulated outdoor scene. The wind-field synthesis module 32 analyzes and calculates an influence of the three-dimensional wind field on falling tracks of the free-falling objects according to the three-dimensional wind field built-up by the wind-field simulation module 31, and then adjusts a falling texture of the free-falling objects according to the influence of the three-dimensional wind field on the falling tracks, so as to simulate dynamic gradation of the free-falling objects in each of the images according to a natural scene based on a physical model. For example, a scene of floating snowflakes is created by adding snowflakes to a wind field. Subsequently, the image synthesis module 35 integrates the aforesaid simulation results into the video film of the outdoor scene, so as to simulate various effects (such as dynamic gradation, ground deposition, and light reflection) of the free-falling objects in the video film. As a result, the outdoor scene shown in the video film is provided with simulated effects approximating real effects of natural weather (such as rain swaying in the wind, snowflakes floating in the wind, or sandstorm) under the influence of different wind fields.

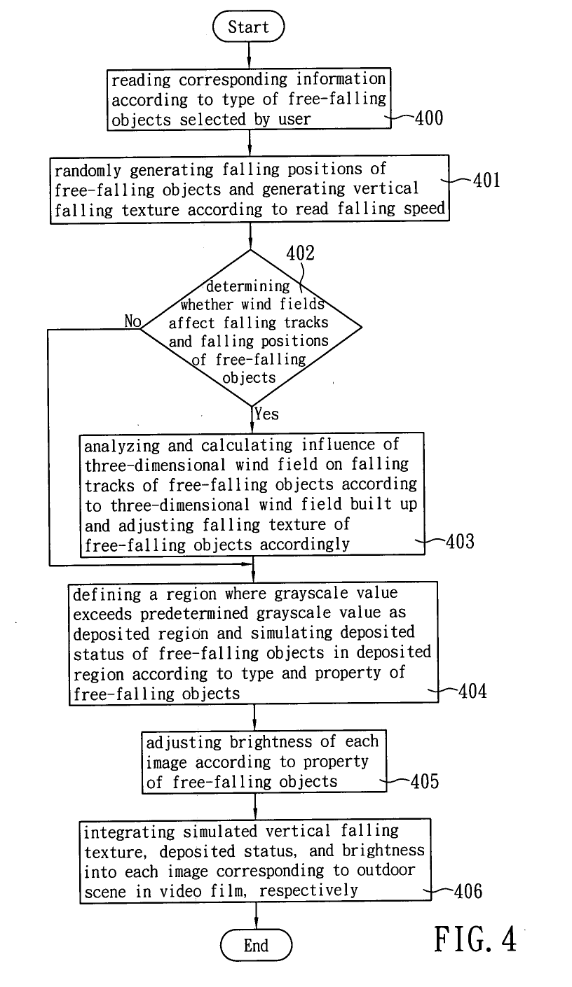

Referring to FIG. 4, the image processing system in the second preferred embodiment of the present invention involves an image processing method comprising the following steps.

In a step 400, the size, the shape, the transparency, and the falling speed corresponding to the free-falling objects are read according to the type of the free-falling objects selected by the user. In addition, in the second preferred embodiment of the present invention, the method determines a possible form of the free-falling objects in the simulated outdoor scene according to the selected type of the free-falling objects, so that the generated free-falling objects are rich in diversity and gradation, thereby enhancing the three-dimensional effects of the outdoor scene. In other embodiments of the present invention, the size, the shape, the transparency, and the falling speed corresponding to the free-falling objects are designed so as to be adjustable by the user.

In a step 401, falling positions of the free-falling objects are randomly generated, and a vertical falling texture of the free-falling objects is generated according to the read falling speed of the free-falling objects.

In a step 402, it is determined according to the type of the free-falling objects selected by the user whether or not wind fields affect falling tracks of the free-falling objects in the simulated outdoor scene. If yes, a step 403 is executed; if not, a step 404 is executed. For example, on a rainy day, raining lines will change their paths under the influence of wind. Thus, raining lines affected by wind fields have complex and changing paths which are difficult to simulate. Presently, in the field of realistic rendering of graphics, a rainy scene with wind is simulated mostly by a simple approach in which inclined raining lines are used. It has never been attempted to add raining lines to a simulated virtual wind field. Therefore, in the second preferred embodiment of the present invention, the influence of wind fields on the falling tracks of raining lines is not considered.

In the step 403, an influence of the three-dimensional wind field on the falling tracks of the free-falling objects is analyzed and calculated according to the three-dimensional wind field built up by the wind-field simulation module 31, and then the falling texture of the free-falling objects is adjusted according to the influence of the three-dimensional wind field on the falling tracks, so as to simulate dynamic gradation of the free-falling objects in each of the images according to a natural scene based on a physical model. For example, a scene of floating snowflake is created by adding snowflakes to a wind field. In other embodiments of the present invention, an intensity and a direction corresponding to the three-dimensional wind field are designed so as to be adjustable by the user.

In the step 404, a grayscale value of each of the images is detected so as to define a certain region of the image where the grayscale value exceeds a predetermined grayscale value (i.e., a brighter region) as a deposited region of the free-falling objects and then simulate a deposited status of the free-falling objects in the deposited region according to a status (such as liquid state or solid state) of the free-falling objects. In other embodiments of the present invention, a deposited amount of the free-falling objects in the deposited region is designed so as to be adjustable by the user.

In a step 405, a brightness of each of the images is adjusted according to the property (such as light reflection or transparency) of the free-falling objects.

In a step 406, the simulated falling texture of the free-falling objects, the simulated deposited status of the free-falling objects in the deposited region, and the adjusted brightness of each of the images are integrated respectively into each of the images corresponding to the outdoor scene in the video film. Thus, various effects (such as dynamic gradation, ground deposition, and light reflection) of the free-falling objects are simulated in the video film according to a natural scene based on a physical model, so that the outdoor scene shown in thee video film is provided with simulated effects approximating real effects of natural weather under the influence different wind fields.

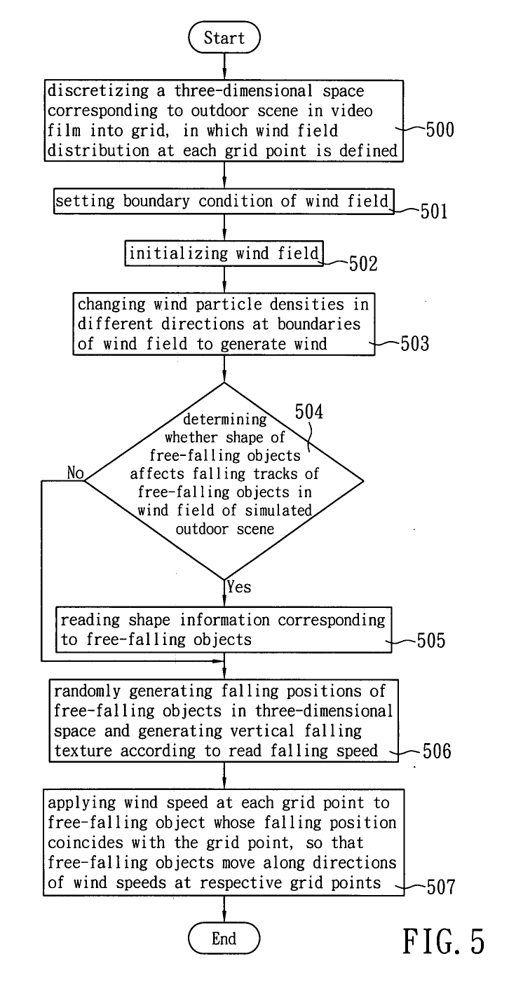

Referring now to FIG. 5, in the second preferred embodiment of the present invention, the three-dimensional wind field is built up essentially by the following steps.

In a step 500, a three-dimensional space corresponding to the outdoor scene in the video film is discretized into an Nₓ*Nₓ*N_{z} grid, and a distribution of the wind field at each grid point is represented by Fᵢ(r,t), wherein r represents each grid point; t is time; i is the number of directions along which wind may move; and Fᵢ is a fluid density moving along each direction i. In the second preferred embodiment of the present invention, a wind field model with 15 directions (i.e., i=15) is established. A direction of the wind field \vec{cᵢ} is represented by the following function:

$${{c}^{}}_{i} = \{ \begin{matrix}( 0 , 0 , 0 ) , i = 0 ; static\_particle \\ ( \pm 1 , 0 , 0 ) , ( 0 , \pm 1 , 0 ) , ( 0 , 0 \pm 1 ) , i = 1 , 2 , … , 6 ; \\ ( \pm 1 , \pm 1 , \pm 1 ) , i = 7 , 8 , … 14 ;\end{matrix}$$

Accordingly, a dynamic model of the three-dimensional wind field of the present invention is constructed and represented by the following function:

$${F}_{i} ( r + {{c}_{i}}^{} , t + Δ t ) = {F}_{i} ( r + t ) + \frac{1}{τ} ( {F}_{i}^{eq} ( u ( r , t ) , ρ ( r , t ) ) - {F}_{i} ( r , t ) )$$

wherein

$$ρ = {\sum }_{i = 0}^{14} {F}_{i}$$

is a wind field density at each grid point;

$$u = {\sum }_{i = 0}^{14} {F}_{i} {{c}_{i}}^{}$$

is a speed field; τ is a relaxation time; and Fᵢ^{eq}(u(r,t), p(r,t)) is a balanced distribution of the wind field and represented by the following function:

$${F}_{i}^{eq} ( u , ρ ) = {ω}_{i} ρ [ 1 + \frac{{{c}_{ia}}^{} {u}_{a}}{{c}_{s}^{2}} + {( \frac{{{c}_{ia}}^{} {u}_{a}}{{c}_{s}^{2}} )}^{2} - \frac{{u}_{a} \cdot {u}_{a}}{2 {c}_{s}^{2}} ] , i = 0 , 1 , … 14$$

wherein \vec{cᵢₐ} is a direction component of the direction \vec{cᵢ} of the wind field in a grid space coordinate a; cₛ²=⅓; and ωᵢ is a parameter to be determined as follows:

$${ω}_{i} = \{ \begin{matrix}2 / 9 , i = 0 ; static\_particle \\ 1 / 9 , i = 1 , 2 , … , 6 ; \\ 1 / 72 , i = 7 , 8 , … 14 ;\end{matrix}$$

In addition to constructing the dynamic model of the three-dimensional wind field in the previous step, a boundary condition of the wind field is set in a step 501. In the second preferred embodiment of the present invention, the wind field has six boundaries including an upper boundary, a lower boundary, a front boundary, a rear boundary, a left boundary, and a right boundary. The lower boundary is the ground. A wind blowing to the ground will rebound, so that the lower boundary is defined as a rebound boundary, and Fᵢ of each grid point at the lower boundary is reversed to generate a reversed value. The remaining five boundaries are defined as open boundaries, and Fᵢ of each grid point at the five boundaries will not be changed.

In a step 502, the wind field is initialized. In the second preferred embodiment of the present invention, an initial status of Fᵢ at each grid point is set to a balanced status. In other words, to begin with, ρ at each grid point is set, and then Fᵢ is calculated according to a weight ω of each direction \vec{cᵢ} of the wind field. In addition, to prevent system instability caused by completely symmetric initialization, it is necessary to add a very small constants ε during the initialization process so as to produce the following initialization function:

Fᵢ(r,0)=ρωᵢ+ε

After finishing the initialization of the wind field, wind particle densities in different directions at the boundaries of the wind field are changed in a step 503 to generate a wind. Assuming the grid point to which wind is to be applied has a wind particle density ρ, the direction of the wind field is \vec{c_{w}}, and a variation of the wind particle density in each direction i at the grid point is ΔFᵢ, i=0,1, . . . 14, then the function ΔFᵢ=λᵢεᵢρV is obtained, wherein λᵢ is determined as follows:

$${λ}_{i} = \{ \begin{matrix}1 / 4 , Δ {c}_{i} = 0 \\ 1 / 16 , Δ {c}_{i} ∈ ( 0 , π / 2 ) \\ 0 , Δ {c}_{i} = π / 2\end{matrix}$$

wherein

$${ɛ}_{i} = \{ \begin{matrix}1 , Δ {c}_{i} ∈ [ 0 , π / 2 ] \\ - 1 , Δ {c}_{i} ∈ ( π / 2 , π ]\end{matrix} ;$$

and Δcᵢ is an included angle between \vec{cᵢ} and \vec{c_{w}}.

In a step 504, it is determined according to the type of the free-falling objects selected by the user whether or not the pattern (i.e., shape) of the free-falling objects affects falling tracks of the free-falling objects in the wind field of the simulated outdoor scene. If yes, a step 505 is executed; if not, a step 506 is executed.

In a step 505, shape information corresponding to the free-falling objects is read according to the type of the free-falling objects selected by the user. Taking snowflakes as the free-falling objects for example, in the second preferred embodiment of the present invention, each snowflake is defined as a sphere with a radius of about 1 to 5 pixels, and 10 snowflake shapes are provided. The position of each snowflake is defined by a coordinate of the center of the sphere, while a grayscale of color of the sphere gradually lightens from the center of the sphere to an edge of the sphere in accordance with a normal distribution. Furthermore, incomplete spheres are also included. As a result, the simulated outdoor scene shows real configurations of the free-falling objects, and the generated free-falling objects are rich in diversity and gradation, thereby enhancing the three-dimensional effects of the outdoor scene.

In a step 506, falling positions of the free-falling objects are randomly generated in a three-dimensional space corresponding to the outdoor scene in the video film, and a vertical falling texture of the free-falling objects is generated according to the read falling speed of the free-falling objects.

In a step 507, a wind speed at each grid point in the dynamic model of the three-dimensional wind field built up previously is applied to a corresponding one of the free-falling objects (such as snowflakes) whose falling position coincides with each said grid point, so that the free-falling objects move along directions of the wind speeds at the corresponding grid points, respectively. Thus, the outdoor scene shown in the video film is provided with simulated effects approximating real effects of natural weather (such as snowflakes floating in the wind).

While the invention has been described by means of specific embodiments, numerous modifications and variations could be made thereto by those skilled in the art without departing from the scope and spirit of the invention set forth in the claims.

1. An image processing system for simulating real effects of natural weather in a video film, configured to simulate free-falling objects related to natural weather in a series of images in a video film of an outdoor scene, the image processing system comprising:
a display device for showing a simulated video film;
a storage device for storing an image processing procedure; and
a processor coupled to the storage device for executing the image processing procedure, wherein the image processing procedure comprises:
defining types of the free-falling objects, wherein each said type of the free-falling objects corresponds to a predetermined size, a predetermined shape, a predetermined transparency, and a predetermined falling speed;
reading the size, the shape, the transparency, and the falling speed corresponding to the free-falling objects according to a selected said type of the free-falling objects, and randomly generating falling positions of the free-falling objects so as to form a vertical falling texture of the free-falling objects in each said image;
detecting a grayscale value of each said image, and defining a region of each said image where the grayscale value exceeds a predetermined grayscale value as a deposited region of the free-falling objects;
simulating a deposited status of the free-falling objects in each said image according to a status of the free-falling objects; and
integrating the vertical falling texture and the deposited status of the free-falling objects into the video film of the outdoor scene.

2. The image processing system of claim 1, wherein the image processing procedure further comprises: building up a three-dimensional wind field in a simulated outdoor scene using air dynamic properties of wind fields.

3. The image processing system of claim 2, wherein the image processing procedure further comprises: determining according to the selected type of the free-falling objects whether or not the three-dimensional wind field affects falling tracks of the free-falling objects.

4. The image processing system of claim 3, wherein the image processing procedure further comprises: analyzing and calculating an influence of the three-dimensional wind field on the falling tracks of the free-falling objects when it is determined that the three-dimensional wind field affects the falling tracks of the free-falling objects, and adjusting the falling texture of the free-falling objects according to the influence of the three-dimensional wind field on the falling tracks.

5. The image processing system of claim 4, wherein the image processing procedure further comprises: determining according to the selected type of the free-falling objects whether or not the shape of the free-falling objects affects the falling tracks of the free-falling objects in the three-dimensional wind field.

6. The image processing system of claim 5, wherein, upon determining that the shape of the free-falling objects affects the falling tracks of the free-falling objects in the three-dimensional wind field, shape information corresponding to the free-falling objects is read according to the selected type of the free-falling objects.

7. The image processing system of claim 6, wherein the shape information defines each said free-falling object a sphere with a radius of about 1 to 5 pixels and with a plurality of different shapes, wherein a position of each said free-falling object is defined by a coordinate of the center of the sphere, and a grayscale of color of the sphere gradually lightens from the center of the sphere to an edge of the sphere in accordance with a normal distribution.

8. The image processing system of claim 1, wherein the image processing procedure further comprises: adjusting a brightness of each said image according to a property of the free-falling objects.

9. The image processing system of claim 8, wherein the property of the free-falling objects is light reflection or the transparency.

10. The image processing system of claim 8, wherein the status of the free-falling objects is a liquid state or a solid state.

11. An image processing method for simulating real effects of natural weather in a video film, applicable to a video film of an outdoor scene so as to simulate free-falling objects related to natural weather in a series of images of the video film, the image processing method comprising:
defining types of the free-falling objects, wherein each said type of the free-falling objects corresponds to a predetermined size, a predetermined shape, a predetermined transparency, and a predetermined falling speed;
reading the size, the shape, the transparency, and the falling speed of the free-falling objects according to a selected said type of the free-falling objects, and randomly generating falling positions of the free-falling objects so as to form a vertical falling texture of the free-falling objects in each said image;
detecting a grayscale vale of each said image and defining a region of each said image where the grayscale value exceeds a predetermined grayscale value as a deposited region of the free-falling objects;
simulating a deposited status of the free-falling objects in each said image according to a status of the free-falling objects; and
integrating the vertical falling texture and the deposited status of the free-falling objects into the video film of the outdoor scene.

12. The image processing method of claim 11, further comprising: building up a three-dimensional wind field in a simulated outdoor scene using air dynamic properties of wind fields.

13. The image processing method of claim 12, further comprising: determining according to the selected type of the free-falling objects whether or not the three-dimensional wind field affects falling tracks of the free-falling objects.

14. The image processing method of claim 13, further comprising: analyzing and calculating an influence of the three-dimensional wind field on the falling tracks of the free-falling objects when it is determined that the three-dimensional wind field affects the falling tracks of the free-falling objects, and adjusting the falling texture of the free-falling objects according to the influence of the three-dimensional wind field on the falling tracks.

15. The image processing method of claim 14, further comprising: determining according to the selected type of the free-falling objects whether or not the shape of the free-falling objects affects the falling tracks of the free-falling objects in the three-dimensional wind field.

16. The image processing method of claim 15, further comprising: upon determining that the shape of the free-falling object affects the falling tracks of the free-falling object in the three-dimensional wind field, reading shape information corresponding to the free-falling objects according to the selected type of the free-falling objects.

17. The image processing method of claim 16, wherein the shape information defines each said free-falling object as a sphere with a radius of about 1 to 5 pixels and with a plurality of different shapes, wherein a position of each said free-falling object is defined by a coordinate of the center of the sphere, and a grayscale of color of the sphere gradually lightens from the center of the sphere to an edge of the sphere in accordance with a normal distribution.

18. The image processing method of claim 11, further comprising: adjusting a brightness of each said image according to a property of the free-falling objects.

19. The image processing method of claim 18, wherein the property of the free-falling objects is light reflection or the transparency.

20. The image processing method of claim 18, wherein the status of the free-falling objects is a liquid state or a solid state.

21. The image processing method of claim 12, wherein the three-dimensional wind field is built up by steps of:
discretizing a three-dimensional space corresponding to the outdoor scene in the video film into an Nₓ*N_{y}*N_{z} grid, so that a distribution of the wind field at each grid point is represented by Fᵢ(r,t), wherein r represents each said grid point; t is time; i is the number of directions along which wind may move; and Fᵢ is a fluid density moving along each said direction i, whereby a dynamic model of the three-dimensional wind field is built up;
setting a boundary condition of the three-dimensional wind field;
initializing the three-dimensional wind field;
changing wind particle densities in different directions at boundaries of the three-dimensional wind field so as to generate a wind; and
applying a wind speed at each said grid point in the dynamic model to a corresponding one of the free-falling objects, so that the free-falling objects move along directions of the wind speeds at corresponding said grid points, respectively.

22. The image processing method of claim 21, wherein the wind field is based on a wind field model with a plurality of directions, with i being equal to an integer N; and a direction of the wind field is represented by \vec{cᵢ}, so that the dynamic model of the three-dimensional wind field is constructed by the following function:
$${F}_{i} ( r + {{c}_{i}}^{} , t + Δ t ) = {F}_{i} ( r + t ) + \frac{1}{τ} ( {F}_{i}^{eq} ( u ( r , t ) , ρ ( r , t ) ) - {F}_{i} ( r , t ) ) ;$$
wherein
$$ρ = {\sum }_{i = 0}^{14} {F}_{i}$$
is a wind field density at each said grid point;
$$u = {\sum }_{i = 0}^{14} {F}_{i} {{c}_{i}}^{}$$
is a speed field; τ is a relaxation time; and Fᵢ^{eq}(u(r,t),ρ(r,t)) is a balanced distribution of the wind field and represented by the following function:
$${F}_{i}^{eq} ( u , ρ ) = {ω}_{i} ρ [ 1 + \frac{{{c}_{ia}}^{} {u}_{a}}{{c}_{s}^{2}} + {( \frac{{{c}_{ia}}^{} {u}_{a}}{{c}_{s}^{2}} )}^{2} - \frac{{u}_{a} \cdot {u}_{a}}{2 {c}_{s}^{2}} ] , i = 0 , 1 , … N ;$$
wherein \vec{cᵢₒ} is a direction component of the direction \vec{cᵢ} of the wind field in a grid space coordinate a; cₛ²=⅓; and ωᵢ is a parameter.

23. The image processing method of claim 22, wherein the boundary condition of the wind field is set in such a way that the wind field has six boundaries including an upper boundary, a lower boundary, a front boundary, a rear boundary, a left boundary, and a right boundary, wherein the lower boundary is a ground and defined as a rebound boundary, so that Fᵢ of each said grid point at the lower boundary is reversed to generate a reversed value, while the other five boundaries are defined as open boundaries, and Fᵢ of each said grid point at the five boundaries will not be changed.

24. The image processing method of claim 23, wherein the step of initializing the three-dimensional wind field comprises setting an initial status of Fᵢ at each said grid point to a balanced status, wherein ρ at each grid point is set, and then Fᵢ is calculated according to a weight ω of each said direction \vec{cᵢ} of the wind field.

25. The image processing method of claim 24, wherein, with ρ being the wind particle density of each said grid point to which wind is applied, \vec{c_{w}} being the direction of the wind field, and a variation of the wind particle density in each said direction i at each said grid point being ΔFᵢ, i=0,1, . . . N, the function ΔFᵢ=λᵢεᵢρV is obtained, wherein the λᵢ determined as follows:
$${λ}_{i} = \{ \begin{matrix}1 / 4 , Δ {c}_{i} = 0 \\ 1 / 16 , Δ c ∈ ( 0 , π / 2 ) \\ 0 , Δ {c}_{i} = π / 2\end{matrix} ;$$
wherein
$${ɛ}_{i} = \{ \begin{matrix}1 , Δ {c}_{i} ∈ [ 0 , π / 2 ] \\ - 1 , Δ {c}_{i} ∈ ( π / 2 , π ]\end{matrix} ;$$
and Δcᵢ is an included angle between \vec{cᵢ} and \vec{c_{w}}.

26. The image processing method of claim 25, further comprising: adjusting a brightness of each said image according to a property of the free-falling objects.

27. The image processing method of claim 26, wherein the property of the free-falling objects is light reflection or the transparency.

28. The image processing method of claim 26, wherein the status of the free-falling objects is a liquid state or a solid state.

29. A computer readable medium, comprising computer executable commands for executing the image processing method of claim 11.
